(19) United States
(12) Patent Application Publication
(10) Pub. No.: US 2012/0001542 A1
(43) Pub. Date: Jan. 5, 2012

(54) SHORT ARC TYPE DISCHARGE LAMP

(75) Inventors: Mitsuru IKEUCHI, Himeji-shi (JP); Akihiro SHIMIZU, Himeji-shi (JP); Tomoyoshi ARIMOTO, Himeji-shi (JP)

(73) Assignee: USHIO DENKI KABUSHIKI KAISHA, Tokyo (JP)

(21) Appl. No.: 13/173,098

(22) Filed: Jun. 30, 2011

(30) Foreign Application Priority Data
Jul. 2, 2010 (JP) 2010-151813

(51) Int. Cl. H01J 61/04

(52) U.S. Cl. 313/633

(57) ABSTRACT

A short arc type discharge lamp wherein a cathode and an anode are arranged opposite to each other in an interior of a light emitting tube and said cathode comprises a main part made from tungsten and an emitter part made from thoriated tungsten, and said emitter part having been diffusion bonded to the main part via a joint face, wherein gaps are formed locally at said joint face of said main part and the emitter part.

### BACKGROUND OF THE INVENTION

1. Field of the Invention

The present invention relates to short arc type discharge lamps and relates specifically to short arc type discharge lamps wherein an emitter part comprising thorium oxide is provided at the cathode.

2. Description of Related Art

As short arc type discharge lamps containing mercury have a short distance between the tip ends of a pair of electrodes arranged oppositely to each other in a light emitting tube and are close to point light sources, they are conventionally used for the light source of exposure devices with a high focusing efficiency by means of a combination with an optical system. Further, short arc type discharge lamps containing xenon are used as light sources for visible light in projectors etc., and recently, they are also used as light sources for the digital cinema. Among these short arc type discharge lamps, lamps are known which are designed to increase the electron emission characteristics by providing an emitter material at the cathode.

In JP-A-33825 the configuration of a known short arc type discharge lamp and the configuration of the cathode thereof are disclosed. FIG. 3 illustrates this conventional technique wherein FIG. 3(A) is a general view of the lamp and FIG. 3(B) shows the configuration of the cathode thereof. As shown in FIG. 3(A), a cathode 11 and an anode 12 made from tungsten are arranged opposite to each other in the interior of a light emitting tube 10 of a short arc type discharge lamp 1. A light emitting substance such as mercury or xenon is enclosed in said light emitting tube 10. In this drawing, a condition is shown where the short arc type discharge lamp 1 is lighted vertically, but depending on the use there are also lamps which are lighted horizontally.

The configuration of the cathode in this lamp is shown in FIG. 3(B). The cathode 12 consists of an emitter part 12a comprising an emitter and a main part 12b formed integrally therewith. This electron emitter part 12a consists of tungsten containing an emitter material such as thorium oxide while the cathode main part 12b is formed from tungsten of high purity. This procedure of making up a lamp with good electron emission characteristics by including an emitter substance in the cathode tip end of the discharge lamp is previously known.

Further, recently limitations have been established for the use of emitter material substances, and there is the desire to avoid the use of large quantities thereof. From the aspect of savings in the scarce resources of thorium and rare earth elements, a use of large quantities thereof is not preferred, and moreover, when thorium is used for the emitter material, the handling of thorium being a radioactive material is restricted by legal regulations. Therefore, the use of the emitter material substance is to be restrained as far as possible, and various discharge lamps have been developed wherein the emitter substance is contained only in the tip end of the cathode such as in the example of the prior art.

In lamps of this kind wherein thorium is used for the emitter substance, the thorium oxide being contained in the thoriated tungsten of the tip end part of the cathode is reduced to thorium atoms by means of the development of a high temperature at the cathode surface, diffuses at the outer surface of the cathode, migrates to the tip end side where the temperature is high and evaporates. By means of this, the work function can be decreased and the electron emission characteristics can be improved.

But in the above mentioned example for the prior art, the emitter substance contributing to the improvement of the electron emission characteristics is actually limited to the emitter substance being contained within a very shallow region from the surface of the cathode tip end. This is because the quantity of the emitter substance being supplied to the cathode tip end surface from the inner portion of the cathode having a lower temperature by means of a heat diffusion is low in comparison to the quantity of the emitter substance being evaporated and consumed by means of the heat of the surface of the cathode tip end where the temperature becomes highest. Thus, even if a large quantity of the emitter substance is contained in the cathode inner portion, the phenomenon arises that the supply thereof from the inner portion to the surface becomes insufficient while there is a shortage of the emitter substance at the surface. Therefore, with the above mentioned known technique there is the problem that although an emitter substance is contained in the cathode tip end, this emitter substance is not utilized sufficiently, and when the emitter material at the cathode tip end surface is depleted, the electron emission characteristics decrease and flicker occurs.

In view of the above-mentioned problems of the known technique, this invention has the object to provide a short arc type discharge lamp having a cathode being configured such that an emitter substance is provided in the tip end, wherein a shortage of the emitter substance at the cathode surface is avoided by means of aiming at an effective utilization of the emitter substance being contained in the inner portion of the cathode tip end, the electron emission characteristics are maintained for a long time despite the reduction of the use level of the emitter substance because this reduction is compensated by a sufficient utilization of the emitter substance, and an extension of the flicker durability of the lamp is intended.

### SUMMARY OF THE INVENTION

To solve the above mentioned problems, in this invention a short arc type discharge lamp wherein a cathode and an anode are arranged opposite to each other in the interior of a light emitting tube and said cathode comprises a main part made from tungsten and an emitter part made from thoriated tungsten having been diffusion bonded to the main part is wherein gaps are formed locally at the joint face of said main part and the emitter part.

Further, in a preferred embodiment, there is the characteric that said main part has a portion with a reduced diameter the tip end thereof having a small diameter and said emitter part is diffusion bonded to the tip end of said portion with a reduced diameter.

Further, in another preferred embodiment, there is the characteristic that said portion with a reduced diameter inclusive of the emitter part is taper-shaped.

Further, in still another preferred embodiment, there is the characteristic that the joint end face of at least one of said main part and said emitter part is formed as a rough face having asperities and said gaps are formed by means of these asperities.

As, according to the present invention, gaps are formed locally at the joint face of the main part and the emitter part, the carbon monoxide formed in the reduction reaction of the thorium oxide contained in the emitter part and the carbon at the vicinity is emitted to the outside of the cathode via the gaps and therefore said reduction reaction is promoted and the thorium oxide contained in the inner portion of the cathode is utilized efficiently. As a result, a depletion of the thorium oxide at the surface does not occur and a lamp with a long flicker durability can be implemented despite the limitations in the use of the emitter substance.

### BRIEF DESCRIPTION OF DRAWINGS

FIG. 1 is a schematic sectional view of an electrode of the discharge lamp according to the present invention.

FIG. 2 is an enlarged schematic explanatory view of a part of FIG. 1.

FIG. 3 is a schematic sectional view of a known short arc type discharge lamp.

### DETAILED DESCRIPTION OF THE INVENTION

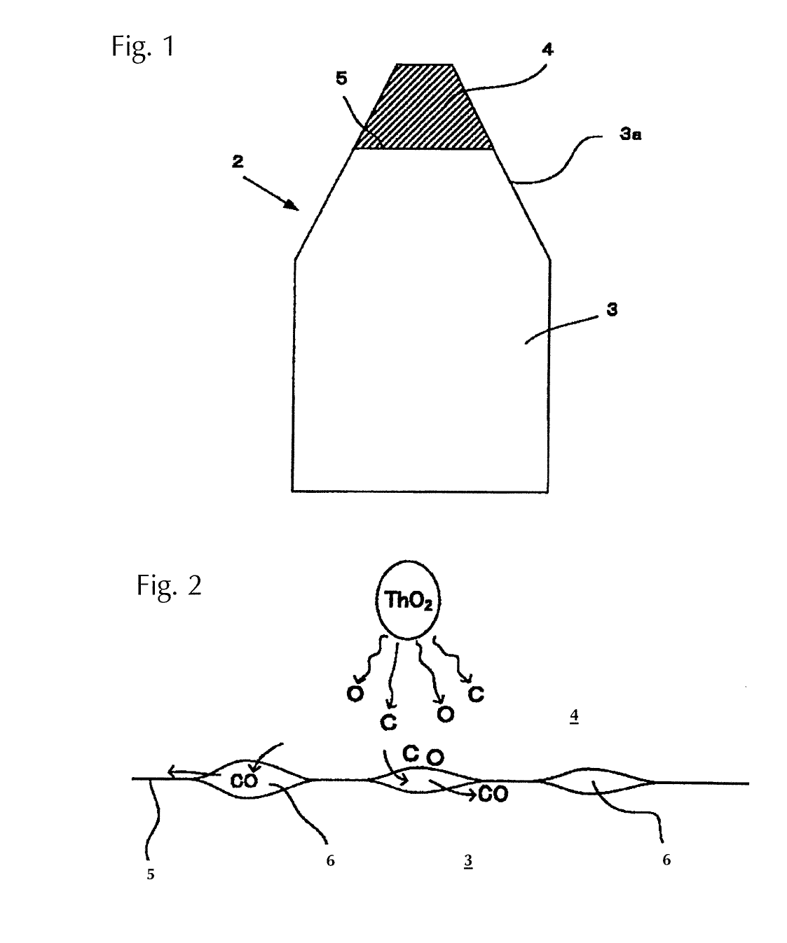

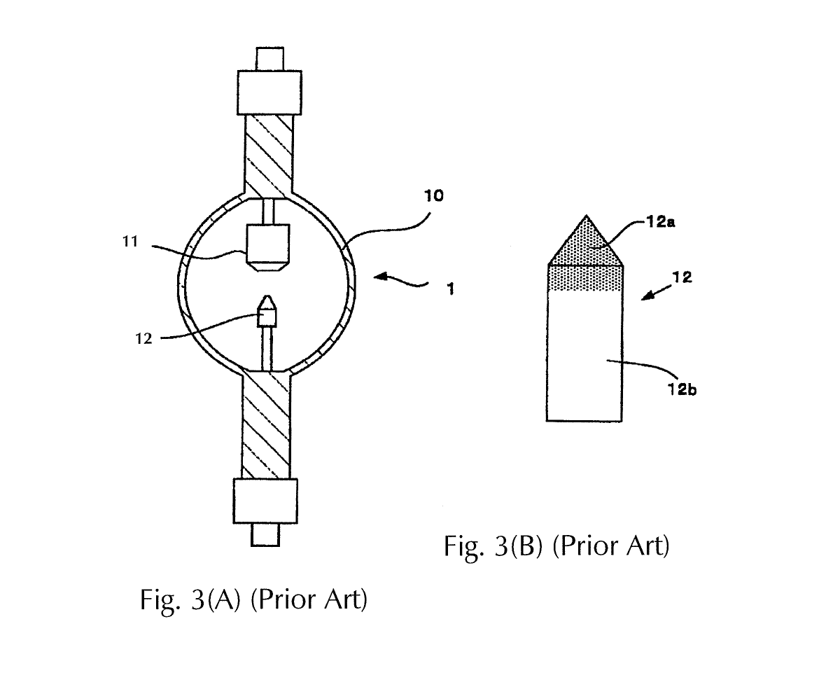

FIG. 1 shows the configuration of the cathode of the short arc type discharge lamp of this invention. The cathode 2 comprises a main part 3 made from tungsten and an emitter part 4 which has been diffusion bonded to the tip end thereof. Here, diffusion bonding means a solid-phase bonding wherein metals are arranged on top of each other and are heated and pressed in the solid state below the melting point so that no plastic deformation occurs, and the atoms of the bonded part are diffused.

Said main part 3 consists of pure tungsten with a purity of, for example, 99.99 wt. %, while the emitter part 4, for which thorium oxide (ThO₂) as the emitter substance has been incorporated into tungsten being the main component, is made of so-called thoriated tungsten. The thorium oxide content amounts to, for example, 2 wt. %.

Normally, the thorium oxide being contained in the thoriated tungsten which makes up the emitter part 4 is reduced to thorium atoms by means of reaching a high temperature during the lighting of the lamp and is diffused at the outer surface of the cathode and migrates to the tip end side where the temperature is high and evaporates. By means of this, the work function can be decreased and the electron emission characteristics can be improved.

Said emitter part 4 has, as a whole, an approximately frustoconical shape. It is bonded to the portion 3a with a reduced diameter of said main part 3, and its tip end face is arranged opposite to an anode which is not shown. The diameter of the portion 3a with a reduced diameter of said main part 3 becomes smaller with the approximation to the tip end side, and in the drawing the shape is tapered. Also the shape of the emitter part 4 is a matching tapered shape. However, the shape of the portion 3a with a reduced diameter of the said main part 3 is not limited to this tapered shape and may also be an arcuate shape, and also the tip end of the emitter part 4 may have a so-called bullet-shaped arcuate shape. Further, it is shown that the emitter part 4 is bonded at the portion 3a with a reduced diameter of the main part 3 but depending from the overall shape of the cathode it may also be bonded to the columnar portion of the main part 3.

In the present invention, gaps 6 are formed locally at the joint face of the main part 3 and the emitter part 4 of said cathode 2, as is shown in FIG. 2. As to these gaps 6, the face of at least one of the main part 3 and the emitter part 4 being joined is made rough by forming asperities, and the gaps 6 are formed by said asperities. The arithmetical average roughness Ra of the rough face because of these asperities is within a range of 0.4 a to 6.3 a. The other face may be a so-called mirror face but may also be moderately rough with an arithmetical average roughness of, for example, 0.012 a to 6.3 a. By means of this, gaps 6 in an order of some um are formed at the joint face of the main part 3 and the emitter part 4.

As was explained above, during the lighting of the lamp a reduction reaction with the carbon atoms solidly dissolved in the tungsten occurs at the surface of the thorium oxide in the thoriated tungsten making up the emitter part 4. Thorium is formed, and at the same time carbon monoxide is generated.

ThO₂+C⇄Th+2CO

When the pressure of the carbon monoxide becomes high, said reduction reaction stops and there is no further generation of thorium. The generated carbon monoxide is solidly dissolved in the surrounding tungsten.

CO⇄[C]w+[O]w

Here, [C]w is the carbon solidly dissolved in the tungsten, and [O]w is the oxygen solidly dissolved in the tungsten. Further, when [C]w and [O]w migrate in the tungsten and diffuse to the outside, the carbon monoxide pressure decreases and the reduction of thorium oxide continues. That is, the reduction of thorium oxide is rate-determined by the diffusion of [C]w and [O]w.

If the bonding of the pure tungsten (main part 3) and the thoriated tungsten (emitter part 4) is close and no gaps 6 are present at the joint face 5, [C]w and [O]w must diffuse in the tungsten because of which the diffusion speed is extremely slow. Therefore, the pressure of the carbon monoxide becomes high in the tungsten in the vicinity of the thoriated oxide and said reduction reaction stops. If, on the other hand, gaps 6 are formed at the joint face 5, [C]w and [O]w do not diffuse in the tungsten over a long distance but reach the gaps 6 within a short time and carbon monoxide is formed. As carbon monoxide is gaseous, it diffuses extremely fast. Thus, the carbon monoxide having reached the gaps 6 is emitted from the gaps 6 to the outside of the cathode, the carbon monoxide pressure in the tungsten decreases and the reduction reaction of thorium is promoted.

Now, an example for the method to produce the cathode will be explained. Thoriated tungsten with a diameter of 10 mm and a thickness of 5 mm and pure tungsten with a diameter of 10 mm and a thickness of 20 mm are prepared. By means of regulating the cutting speed and the feed rate in the turning process, the surface roughness of at least one joint face of the thoriated tungsten and the pure tungsten is brought into a range of a center line average roughness of 0.4 a to 6.3 a. Next, the joint faces of the thoriated tungsten and the pure tungsten are fit together and an axial compressing pressure of about 2.5 kN is applied in a vacuum. Further, the temperature of the joint portion is brought to approximately 2000° C. by heating by means of applying a current and the thoriated tungsten and the pure tungsten are diffusion bonded for about 5 minutes. As a result, gaps 6 in an order of some μm are generated at the joint interface 5 within the above mentioned range of the surface roughness.

By means of a cutting process of the material after the diffusion bonding, a cathode 2 the tip end of which being the emitter part 4 (thoriated tungsten) and the rear being the main part 3 (pure tungsten) is obtained. It is possible to observe the presence of the gaps 6 by grinding a section of the joint cathode and observing with a scanning electron microscope (SEM) or a metal microscope and the like.

Because, as was explained above, according to the present invention gaps are formed at the joint face of the cathode main part (tungsten) and the emitter part (thoriated tungsten), the carbon monoxide generated at the time of the reduction reaction between the thorium oxide of the emitter part and carbon can be quickly eliminated by diffusion and the pressure of the carbon monoxide in the tungsten can be kept low, because of which said reduction reaction is promoted and the thorium oxide being present in the interior of the cathode can also be made to function effectively. Thus, not only the thorium oxide at the surface part of the cathode is used, and a short life cycle because of the depletion of the emitter substance can be avoided. Thus, a cathode configuration being able to also fulfill the social demand of limiting the use level of the emitter substance can be implemented, and as to the concrete configuration, despite the configuration where the emitter part is bonded at the portion with a reduced diameter of the cathode main part, the function to avoid flicker can be brought forth for a sufficiently long time.

1. A short arc type discharge lamp wherein a cathode and an anode are arranged opposite to each other in an interior of a light emitting tube and said cathode comprises a main part made from tungsten and an emitter part made from thoriated tungsten, and said emitter part having been diffusion bonded to the main part via a joint face,
wherein gaps are formed locally at said joint face of said main part and the emitter part.

2. The short arc type discharge lamp according to claim 1, wherein said main part has a portion with a reduced diameter the tip end thereof having a small diameter and said emitter part is diffusion bonded to the tip end of said portion with a reduced diameter.

3. A short arc type discharge lamp according to claim 2, wherein said portion with a reduced diameter inclusive of the emitter part is taper-shaped.

4. A short arc discharge lamp according to claim 1, wherein the joint end face of at least one of said main part and said emitter part is formed as a rough face having asperities and said gaps are formed by means of these asperities.

5. A short arc type discharge lamp according to claim 4, wherein the arithmetical average roughness Ra of the rough face is within a range of 0.4 a to 6.3 a and the arithmetical average roughness of the face joined to said rough face is 0.012 a to 6.3 a.
